(19) United States
(12) Patent Application Publication
(10) Pub. No.: US 2002/0142193 A1
(43) Pub. Date: Oct. 3, 2002

(54) Integrated foil battery and electronic circuitry

(76) Inventor: Tzung-Cheng Yang, Silver Spring, MD (US)

Correspondence Address: TZUNG-CHENG YANG, 13245 TREBLECLEF LANE, SILVER SPRING, MD, 20904, US

(21) Appl. No.: 09/778,155

(22) Filed: Feb. 6, 2001

(51) Int. Cl. H01M 10/00

(52) U.S. Cl. 429/7; 429/162

(57) ABSTRACT

This invention eliminates the requirement of a battery compartment of electronic devices, so that the size of the electronic devices can be greatly reduced. This invention is very usefully especially for medical devices and portable devices or the like.

### CROSS-REFERENCE TO RELEATED APPLICATIONS

U.S. Patent Documents

| | | | |
|---|---|---|---|
| 5886688 | Jun., 1995 | Fifield et al. | 345/206 |
| 5983073 | Apr., 1997 | Ditzik | 455/11.1 |

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present apparatus is for use in for example portable devices such as personal digital assistant (PDA), portable computer, cellular phone, beacon generator, portable game,watch or the like, as well as medical devices such as pacemaker, defibrillator, artificial heart, and etc. Up to the present time, these devices require a battery compartment to house the battery. Thus the dimension of the electronic devices can only be reduced to a certain amount.

### BRIEF SUMMARY OF THE INVENTION

This invention integrates foil battery and electronic circuitry for example on a printed circuit board (PCB) to eliminate the requirement of battery compartment so that the size of the portable devices or medical devices or the like can be greatly reduced. An alternative arrangement is to attach the foil battery on the housing of the device. Under such arrangement, a battery compartment is still not required.

### BRIEF DESCRIPTION OF THE SEVERAL VIEWS OF THE DRAWING

With reference to the drawings:

FIG. 1 shows the front view and the side view of the invention with the foil battery attached to the printed circuit board with electronic circuitry on it.

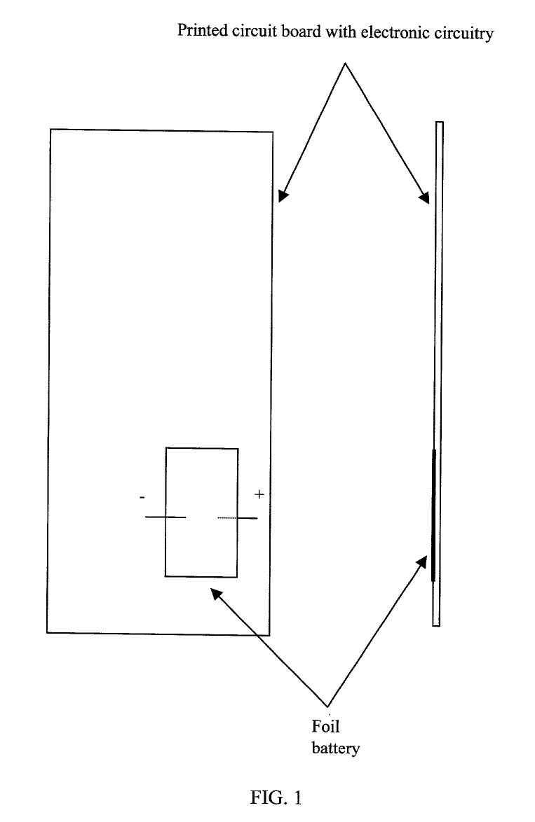

FIG. 2 shows an alternative arrangement of the invention with the foil battery attached to the housing.

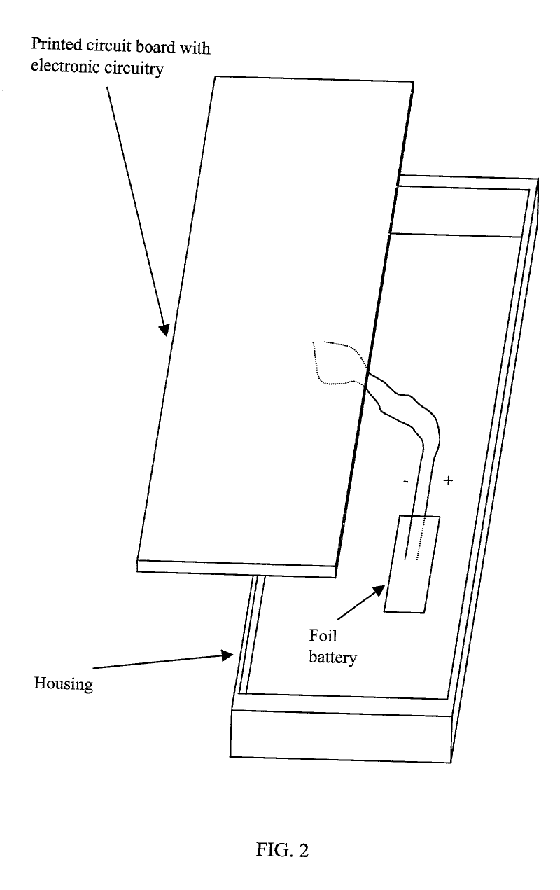

### DETAILED DESCRIPTION OF THE INVENTION

Unlike conventional portable devices or medical device, this apparatus integrates foil battery and electronic circuitry for example on a printed circuit board (PCB), so that a battery compartment is not required and thus the size of a portable device or a medical device or the like can be greatly reduced.

With this technology, a PDA can be reduced to the size as small as a credit card. An alternative arrangement is to attach the foil battery on the housing of the device. Two electrical wires make the connection between the printed circuit board and the foil battery. Under such arrangement, a battery compartment is still not required. A foil battery is a kind of battery, which can be as thin as a piece of foil. The foil battery is available at Front Edge Technology, Inc., Baldwin Park, Calif.

I claim:

1. An assembly comprising of:
a) a substrate;
b) a foil battery attached to the substrate; and
c) an electronic circuitry built on the substrate with the foil battery supplies power to the electronic circuitry.

2. An assembly comprising of:
a) a substrate;
b) a foil battery;
c) an electronic circuitry build on the substrate with the foil battery supplies power to the electronic circuitry.
d) a housing with the foil battery attached to it while the substrate and the electronic circuitry reside in it.
